(19) United States
(12) Patent Application Publication
(10) Pub. No.: US 2018/0322519 A1
(43) Pub. Date: Nov. 8, 2018

(54) Mobile Coupon System

(71) Applicant: Walmart Apollo, LLC, Bentonville, AR (US)

(72) Inventors: Danika Goecke, Lowell, AR (US); Neelima Shali, Bentonville, AR (US); Karletha Dorsey, Bentonville, AR (US); Sudha R. Garikapati, Bentonville, AR (US); Shipra Rane, Bentonville, AR (US)

(73) Assignee: Walmart Apollo, LLC, Bentonville, AR (US)

(21) Appl. No.: 15/971,273

(22) Filed: May 4, 2018

Related U.S. Application Data
(60) Provisional application No. 62/501,313, filed on May 4, 2017.

(51) Int. Cl. G06Q 30/02; H04M 1/725

(52) U.S. Cl. CPC G06Q 30/0222; H04M 1/72522; G06Q 30/0238

(57) ABSTRACT

A mobile application or website may be provided with a “Coupons” category. With this category, consumers may view all the coupons available for products or services in real time. This feature may be used to compile a shopping list before their trip to a retail store. It will also provide the consumer an option to scan any external coupons, such as paper coupons or coupons and incentives from other sources. All available coupons can be integrated into a single code. Once the single code is scanned at checkout or point of sale, any coupon on the website may be applied to the items that have a matching coupon. If the consumer has manually scanned in external coupons, those coupons are also applied to applicable items.

### BACKGROUND

### 1. Technical Field

The present disclosure relates to a system and method for presenting, applying and redeeming coupons and other incentives in mobile applications.

### 2. Introduction

Coupons and other incentives are commonly offered to induce consumers to purchase or try products or services. Traditionally, paper coupons have been used in the retail environment. More and more consumers are shopping, making purchases and obtaining coupons via the Internet or mobile apps. However, the current coupon process at brick and mortar retail stores is paper based. The consumer goes to the retailer's website and looks for the day's list of available coupons. Then the consumer manually selects all coupons they are interested in, prints, and cuts those coupons out. The consumer brings in stacks of coupons with them to the retail store and presents them to the cashier at checkout. Consumers may also bring in any other coupons received in mailers or the local newspaper at checkout. In either scenario, the consumer handles a paper coupon and performs a manual process of printing, cutting, and carrying the coupon until checkout. The cashier manually scans each individual coupon at checkout time.

This is a time consuming process for the customers, as well as cashiers, and is not sustainable in the growing mobile world. During holidays and peak hours this greatly increases the waiting time for customers at checkout registers which in turn, decreases the amount of items sold, productivity, and many other qualities.

In addition, many consumers have accounts used at on-line retailers. These accounts may not be fully synchronized with the in-store shopping experience. For example, a consumer's on-line account may have accumulated credits, rewards, or other incentives that the consumer may wish to apply in-store, and combine with coupons. There is a need for systems to synthesize and streamline the application of coupons and incentives in the mobile space.

### SUMMARY

A system based on the concepts disclosed herein can, for example, include: a coupon database configured to receive and store data regarding available coupons; a mobile application in communication with the coupon database and configured to present the available coupons to a consumer; receive and store images of paper coupons; interface with consumer account to determine available savings; generate a code for the consumer's purchase, the code representing the applicable e-coupons and the paper coupons for the purchase and the savings from the account; a point of sale module disposed a physical store and configured to receive a scan of the code; purchase module to interpret the code to determine the applicable coupons and the savings account balance; and a redemption module in communication with the purchase module to redeem the coupons and adjust the balance of the account.

A system based on the concepts disclosed herein can, for example, include: receiving a first data structure representing available e-coupons for items; presenting the available coupons to a consumer via a computing device; receiving an image of a paper coupon; validating the paper coupon based on the image; identifying the consumer's purchased items; identifying available e-coupons and scanned coupons that apply to the purchased items; presenting suggestions to the consumer of actions to take to meet coupon requirements based on the purchased items; determining an available balance in an account of the customer; creating a single code representing the applied coupons and providing the code to a mobile device of the consumer; scanning the code at a point of sale; automatically applying the account balance, available-coupons and the paper coupons to the purchased items; and redeeming the applied coupons.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example flowchart for systems configured as described herein;

FIG. 2 illustrates an example system architecture;

FIG. 3 illustrates an example embodiment; and

FIG. 4 illustrates an example computer which can be used to practice the concepts disclosed herein.

### DETAILED DESCRIPTION

A system, method and computer-readable media are disclosed which provide for applying coupons digitally from a mobile device. Embodiments of the invention apply coupons digitally using a single code from a consumer's mobile device using a mobile app or website. For customers who shop at a physical location, the code may be applied at a point of sale using the mobile application or website. The single code can be applied through self-check out registers or cashier led registers. For customers who shop online, the code can be applied via the website.

Various embodiments of the disclosure are described in detail below. While specific implementations are described, it should be understood that this is done for illustration purposes only. Other components and configurations may be used without parting from the spirit and scope of the disclosure.

Embodiments of the invention may provide the following benefits over the current state of the art:

Consolidate multiple coupons at one time using a single digital UPC barcode;

Ability to integrate with both retailer hosted and external vendor coupons;

Ability to integrate with consumer's accounts by allowing real time redemption of accumulated dollars;

Faster and easier checkout process when using coupons and/or consumer's accounts accumulated dollars;

Increased customer traffic; and

Automated process of sending coupons to a Digital Redemption Warehouse.

Embodiments of the invention solve a problem originating in the field of electronic coupon processing. The application of many different e-coupon codes, and of paper coupons, required each code to be processing individually, limiting the number of transactions a system can process, increasing network traffic and wasting processor resources. In addition, e-commerce and e-shopping systems should be able to match coupons with purchased items, validated the coupons, and make coupons available for purchased items.

In exemplary embodiments, a mobile application or website may be provided with a “Coupons” category. With this category, consumers may view all the coupons available for products or services in real time. This feature may be used to compile a shopping list before their trip to a retail store. It will also provide the consumer an option to scan any external coupons, such as paper coupons or coupons and incentives from other sources. All available coupons can be integrated into a single code, such as digital code, UPC barcode, QR code, and the like. Once the single code is scanned at checkout, any coupon on the website may be applied to the items that have a matching coupon. If the consumer has manually scanned in external coupons, those coupons are also applied to applicable items. Once the items have been paid for, the consumer's receipt may display the coupons applied and total savings. An option to apply the consumer's account credits if logged into the account may also be provided. The credits may also be included in the single code.

Current websites may display all the available coupons, but do not provide the option to apply them at checkout automatically, combine paper coupons, or combine the coupons into a single code for processing. With the present system it is possible to apply the coupons automatically, quickly and efficiently. This allows the point of sale system top accept more transactions and process more items for purchase. In addition, the back-end systems are able to process, verify and apply coupon transactions faster, allowing more point of sale systems to access the back-end systems.

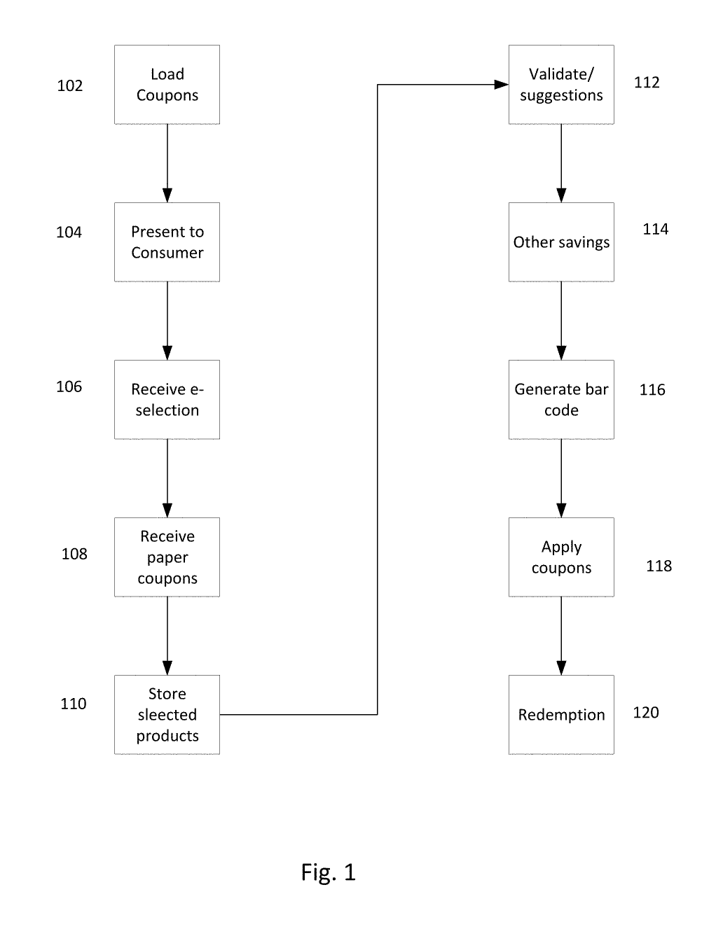

FIG. 1 illustrates an example method 100 according to an embodiment of the invention. A product manufacturer or other coupon issuer may create paper or electronic coupons for a product or service. The electronic coupons may be managed by an e-coupon service. The e-coupon service may store the coupons in a database. A seller of products or services, for example a retailer, may subscribe to the e-coupon service. When a consumer is shopping the retailer's website, mobile app, or the like, the available coupons from the e-coupon service may be loaded on to the retailer's site or app 102. Information regarding any requirements that must be meet in order to redeem the coupon may also be provided and stored. The requirements may include coupon codes, expiration dates, a number or products that must be purchased (buy two get one free), a minimum purchase value, etc.

The consumer may request to view the available coupons and the app or website may present a page displaying the available coupons 104. The option to auto-apply all available coupons the consumer's purchases may also be presented. Another option is to automatically apply all of the available coupons to the consumer's purchase.

The consumer may also opt to print out the coupons or may have paper copies of coupons, for example from traditional newspaper circulars 108. The system functions to allow the consumer the scan or take a picture of the coupon. The scan or picture of the coupon may be saved by the system, for example to the consumer's account or otherwise associated with the consumer during their visit to the site or app. The system may also validate the paper coupons with a validation service, such as the National Clearing House. The coupon may be validated at the time of the scan or picture.

The consumer may continue to navigate the website to select products to purchase and coupons to apply. The products selected for purchase may be stored in an online shopping cart as is known in the art 110. The consumer may also be able to create a shopping list of desired items which the consumer will then travel to a physical store to purchase. The system automatically identifies applicable coupons based on the items selected and added to the shopping list or cart 112. Identifiers for the items, such as UPC codes, are compared to the available coupons stored in the coupon database. Matches indicate that a coupon is available for that product. When a coupon is identified, the coupon is associated with the item in the shopping list or cart. The identification of available coupons may occur as each item is added to the cart or list or as a batch, for example upon check-out or finalizing a shopping list. In an exemplary embodiment, a table is created for the identifiers for the items and the coupon for the item is associated with the respective identifier.

A validation checks that all requirements for the coupons are met. For example, if the coupon is for $1.00 off two items, it is determined if the consumer is purchasing two items. This may be accomplished may examining the contents of the shopping cart or list. If the items are not present, the coupon is not validated. The system may make suggestions to the consumer in such a case. In the example where only one item is purchased, the system may provide a message to the consumer that if they purchase another item, the coupon may be applied

The system may also suggest items for purchase based on the available coupons. The suggestions may be based at least in part on the consumers' preferences. For example, the consumer's purchase history may be known. If the consumer is a frequent purchaser of an item, the system may identify that a coupon is available for that item. If the consumer is not currently purchasing the item, the system may recommend that item with a message that a coupon or incentive is available for the item. The item and coupon details may be presented to the consumer.

In additional embodiments, the system may incorporate any savings/credits that have accumulated for the consumer from other sources, such as an account the consumer may have with the retailer 114. Many retail websites allow a consumer to create an account with the retailer. As transactions occur for customers with accounts, those transaction are reported to a server and the account updated. The account of the customer may also he augmented by refunds assigned to the customer in response to determining that a third party offers a lower price for a product purchased by the customer. The refunds may be determined according to the difference between the purchase price for the product and the lower third party price. An example of such a system is the Savings Catcher® account offered by Walmart.com. The system may present the consumer with an option to apply any saving that have accumulated in the account to the current transaction.

The system may generate a single code representing all of the coupons and account credits 116. The code may be a bar code, QR code, etc. that the user can present at a point of sale to have the discounts applied to the purchase, similar to how paper coupons are traditionally processed at the point of sale. However, one code now represents all of the paper coupons, e-coupons, and account credits. The code may be displayed on the consumer's mobile device via the app or website. The code is scanned, the purchase transaction completed and savings applied 118. The paper and e-coupons are redeemed via a coupon redemption process, for example as is known in the art 120. The account, if utilized, is “debited” the amount applied to the current purchase.

In an exemplary embodiment, a database record is stored for the customer. A customer identifier is associated with a Savings Catcher® account balance. The paper and e coupons for the customer are also associated with the customer identifier. Information regarding the purchased items is gathered at the point of sale system, matched with the coupons, and the savings applied. In some case the point of sale system may he a website, or similar e-commerce site.

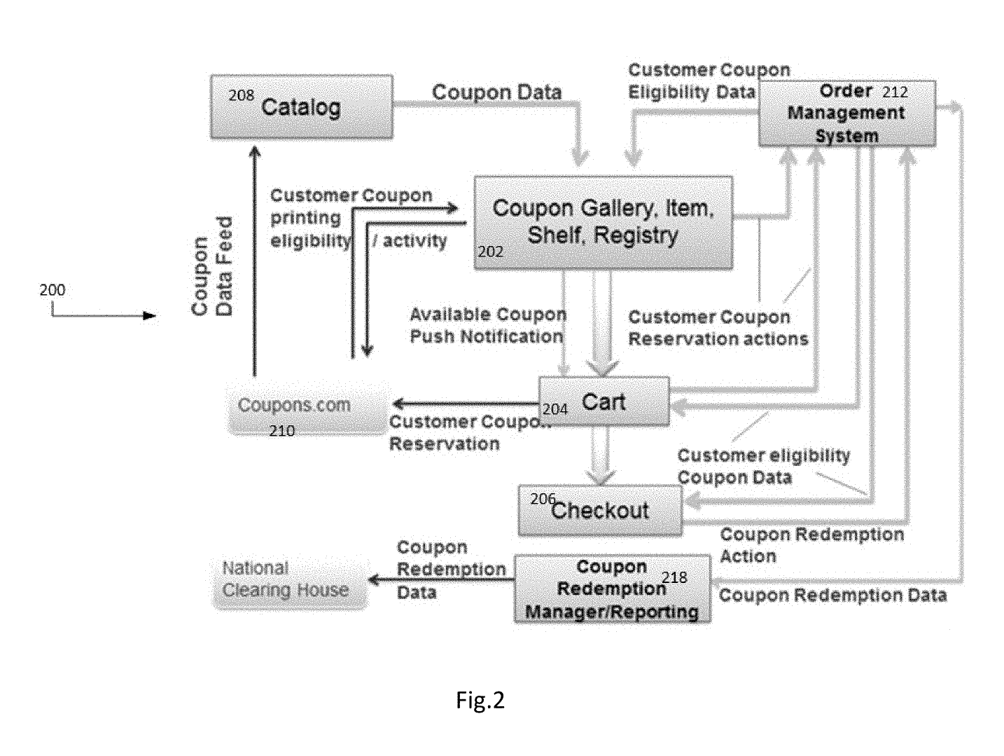

FIG. 2 illustrates an example system architecture 200 according to an embodiment of the invention. The system shown in FIG. 2 illustrates various modules as separate from each other. However, the modules and functionality may be combined into one or modules on one or more servers.

The system may include a shopping module 202. Shopping module 202 may function to manage the electronic shopping process. The shopping module 202 may gather and present information to the consumer, store selected items in a shopping cart, and manage the checkout process. The shopping module may include separate shopping cart 204 and checkout 206 modules. The shopping module 202 may interface with one or more backend systems and databases to gather and present information to the consumer. The shopping module 202 may function to present items available for purchase, the available coupons, items on a shelf, etc. to the consumers.

One of the systems that interfaces with the shopping module may be coupon module 208. The coupon module may communicate with the e-coupon service 210 to receive data regarding coupons and offers. In certain embodiments, the coupon module 208 may communicate directly with the manufacturer or other issuer to receive data regarding the coupon. The coupon module may include a database that stores the information received from the e-coupon service regarding the coupon.

The shopping module 202 may communicate with the shopping cart module 204 when an item is elected for purchase. The shopping cart module stores the items selected by the consumers in a virtual shopping cart, for example, by associating the items with the consumers ID or account. As items are added to the cart push notifications may be presented to the consumer. The push notification may include a notice of coupons available for that item, as well as the suggestion information noted above.

The items added to the shopping cart may be purchased. This may be the completion of the in-store or on-line shopping trip. In-store, the customer may use the mobile app or website. The app or website may ask if the customer wishes to apply any account savings. The system can generate the single code. The code is scanned at the point of sale. An order management system 212 confirms the eligibility of the coupons, for example, is the correct item being purchased and if any other requirements met.

After the checkout process in completed, a redemption module 218 manages the redemption process. The redemption module communicates with the order management system 212 to receive information about the products purchased and the applicable coupons. The coupon and redemption information with a clearing house in a known manner to redeem the coupons.

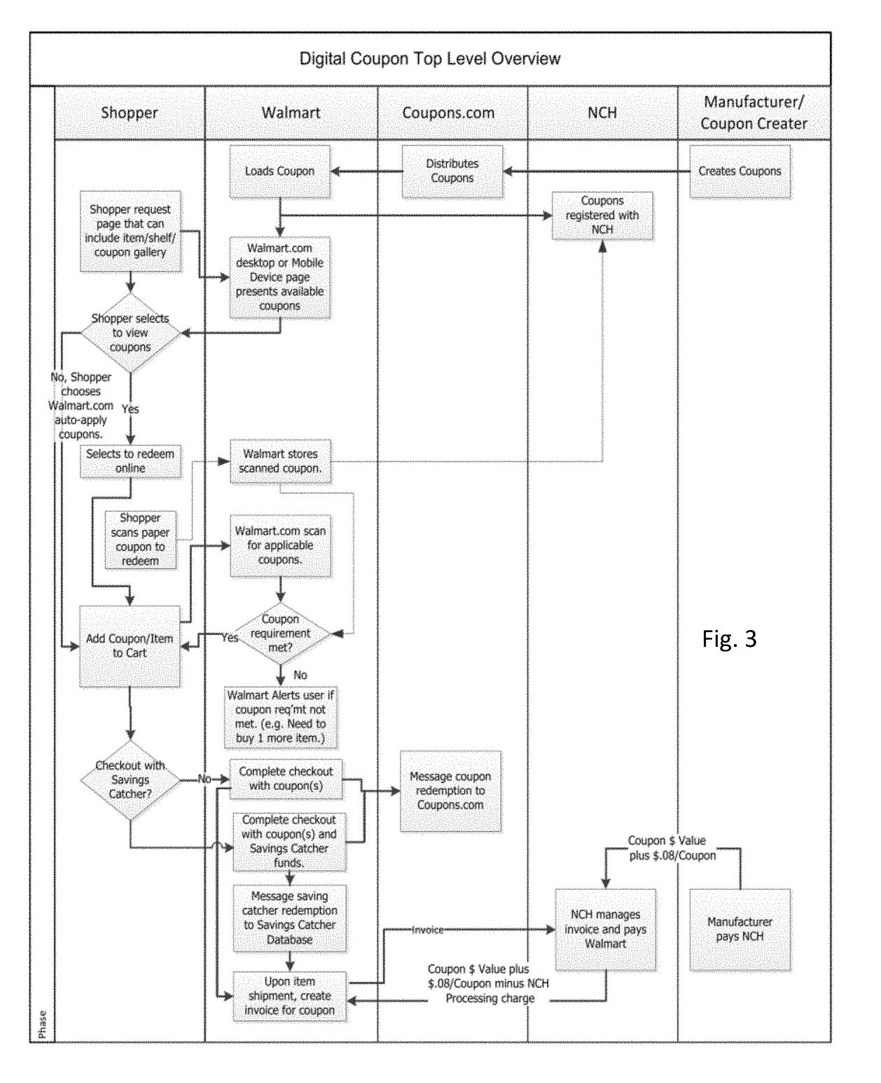

FIG. 3 illustrates an exemplary method with the various functions assigned to different swim lanes that perform the different functions. In this example, the swim lanes are assigned to the customer, the retailer, the e-coupon service, and the coupon clearing house.

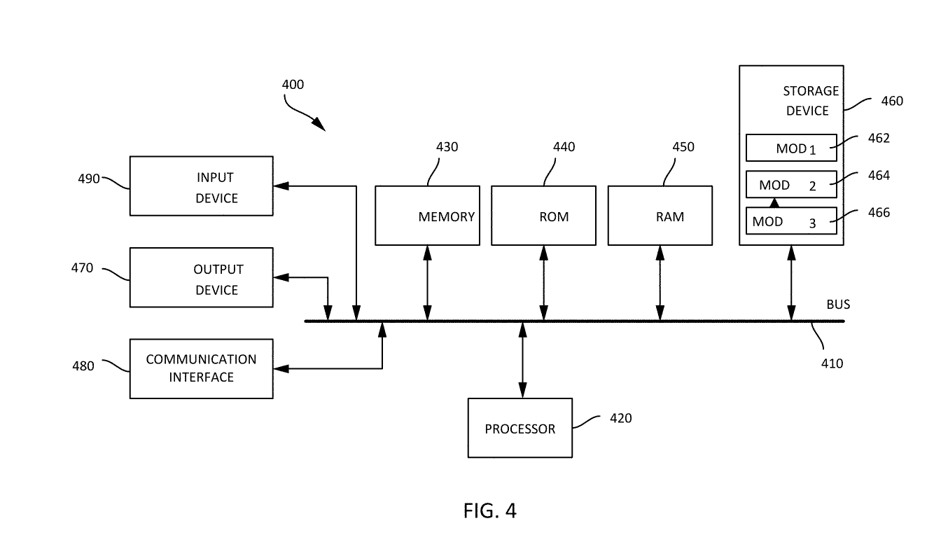

With reference to FIG. 4, an exemplary system 400 includes a general-purpose computing device 400 which can be used for performing the concepts disclosed herein. This computing device 400 includes a processing unit (CPU or processor) 420 and a system bus 410 that couples various system components including the system memory 430 such as read only memory (ROM) 440 and random access memory (RAM) 450 to the processor 420. The system 400 can include a cache of high speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method, comprising:
receiving a first data structure representing available e-coupons for items;
presenting the available coupons to a consumer via a computing device;
receiving an image of a paper coupon;
validating the paper coupon based on the image;
identifying the consumer's purchased items;
identifying available e-coupons and scanned coupons that apply to the purchased items;
presenting suggestions to the consumer of actions to take to meet coupon requirements based on the purchased items;
determining an available balance in an account of the customer;
creating a single code representing the applied coupons and providing the code to a mobile device of the consumer;
scanning the code at a point of sale;
automatically applying the account balance, available-coupons and the paper coupons to the purchased items; and
redeeming the applied coupons.

2. The method of claim 1, further comprising:
identifying if the requirements of a coupon are met; and
suggesting actions to meet the requirements.

3. The method of claim 1, further comprising:
analyzing the available coupons;
analyzing the items in the consumer's purchase history;
identifying matches between the purchase history and the available coupons; and
suggesting items for purchase based on the purchase history and the available coupons.

4. The method of claim 1, further comprising:
receiving a shopping list from the consumer, the shopping list including items for purchase;
identifying items on the list having applicable coupons; and
presenting the available coupons to the consumer for purchase.

5. A system comprising:
a coupon database configured to receive and store data regarding available coupons;
a mobile application in communication with the coupon database and configured to present the available coupons to a consumer; receive and store images of paper coupons; interface with consumer account to determine available savings; generate a code for the consumer's purchase, the code representing the applicable e-coupons and the paper coupons for the purchase and the savings from the account;
a point of sale module disposed a physical store and configured to receive a scan of the code;
purchase module to interpret the code to determine the applicable coupons and the savings account balance; and
a redemption module in communication with the purchase module to redeem the coupons and adjust the balance of the account.

6. The system of claim 5, further comprising:
the purchase module identifying if the requirements of a coupon are met; and
suggesting actions to meet the requirements.

7. The system of claim 5, further comprising:
the purchase module analyzing the available coupons;
analyzing the items in the consumer's purchase history;
identifying matches between the purchase history and the available coupons; and
suggesting items for purchase based on the purchase history and the available coupons.

8. The method of claim 5, further comprising:
the mobile application receiving a shopping list from the consumer, the shopping list including items for purchase;
identifying items on the list having applicable coupons; and
presenting the available coupons to the consumer for purchase.

9. The system of claim 5, further comprising:
an account module interfacing with the mobile application to provide the account information.
